(19) United States
(12) Patent Application Publication
(10) Pub. No.: US 2024/0352793 A1
(43) Pub. Date: Oct. 24, 2024

(54) DEMOLITION GUARD

(71) Applicant: Edward Thomas Haley, Martinsville, IN (US)

(72) Inventor: Edward Thomas Haley, Martinsville, IN (US)

(21) Appl. No.: 18/304,863

(22) Filed: Apr. 21, 2023

(51) Int. Cl. E06C 7/10; E06C 1/383

(52) U.S. Cl. CPC E06C 7/10; E06C 1/383

(57) ABSTRACT

A guard for protecting an object with a front panel that extends between front legs, a rear panel that extends between rear legs, a top panel coupled to the upper portion of the guard extending across a space between the front and rear panels, where the front and rear panels are rotatable around an axis of rotation through an angle of rotation extending between at least 0 and 45 degrees.

### BACKGROUND

The present disclosure relates to a protective guard for use during demolition and construction.

There is a risk for objects to accidentally fall or be dropped from substantial heights during construction, roofing, or other outdoor maintenance activities. For example, building and/or roofing materials fall from a roof that is multiple stories above ground. The impact of such falling objects can be severe and has the potential to cause significant damages. Outdoor furnishings, appliances, and/or other objects are at risk to be damaged or destroyed by such impacts.

There is a need for protecting objects that cannot be moved during construction. This can be accomplished through a combination of several design features described below.

### BRIEF DESCRIPTION OF THE DRAWINGS

FIG. 1 is a perspective view of a guard that is positioned to protect an object.

FIG. 2 is a side elevation view of the FIG. 1 guard and object.

FIG. 3 is a perspective view of the FIG. 1 guard in a closed and collapsed configuration.

FIG. 4 is a bottom plan view of the FIG. 3 guard.

FIG. 5 is a perspective view of the FIG. 1 guard in an open and collapsed configuration.

FIG. 6 is a perspective view of the FIG. 1 guard in an open and extended configuration.

FIG. 7 is a perspective view of an intermediate panel assembly.

FIG. 8 is a perspective view of an intermediate pin.

FIG. 9 is a perspective view of a guard assembly including the FIG. 1 guard and the FIG. 7 intermediate panel assembly.

FIG. 10 is a perspective view of another embodiment of a guard assembly including the FIG. 1 guard and the FIG. 7 intermediate panel assembly.

FIG. 11 is a perspective view of yet another embodiment of a guard assembly including the FIG. 1 guard and the FIG. 8 intermediate pin.

FIG. 12 is a perspective view of a hood and a barrier accessory for a ladder.

### DESCRIPTION OF THE SELECTED EMBODIMENTS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. One embodiment of the claimed invention is shown in great detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

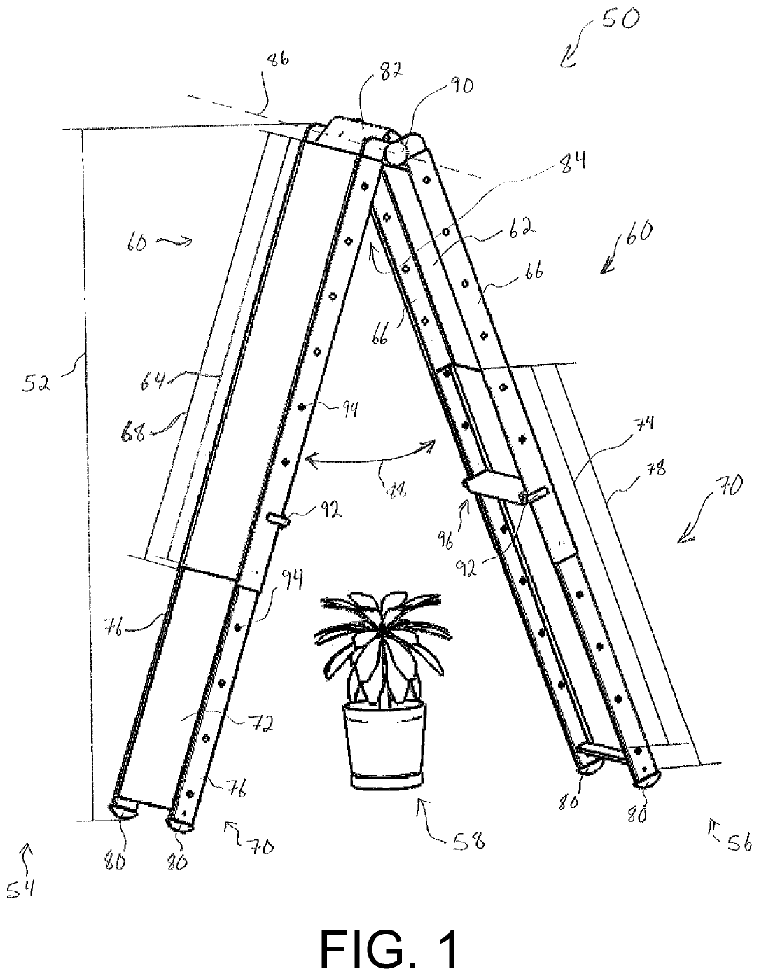

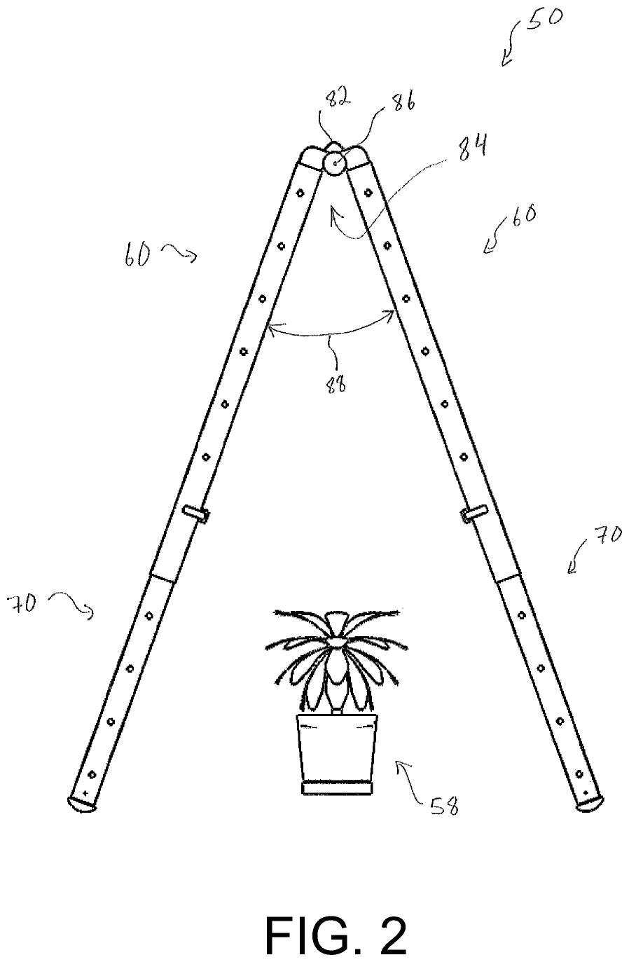

Referring to FIG. 1 and FIG. 2, a guard 50 is positioned to protect an object 58 from items falling from above. Guard 50 shields object 58 in a vertical direction from objects that may fall. Such falling objects first contact the guard which deflects them away from object 58. Particularly, guard 50 is configured to protect object 58 from debris or building materials that may fall during installation or removal of roofing systems. For example, guard 50 may protect against shingles, rafters, ridge boards, flashing, gutters, insulation, and/or other similar materials. Guard 50 is rigid in construction such that when one or more objects fall onto guard 50, guard 50 is configured to withstand considerable impact. In one embodiment, guard 50 is configured to withstand the impact of a square of roofing shingles falling from twenty feet. In another embodiment, guard 50 is configured to withstand the impact of one or more objects whose weight exceeds 240 pounds and which are falling from twenty feet above guard 50.

The position and arrangement of guard 50 can adjust to protect different types of objects 58. For example, the guard may adjust to cover air conditioning units, plants, planters, statues, pipes, and/or other objects.

Guard 50 generally includes two upper panel assemblies 60, two lower panel assemblies 70, and a top plate 82. One upper panel assembly 60 and one lower panel assembly 70 are positioned on a front side 54 of guard 50, and one upper panel assembly 60 and one lower panel assembly 70 are positioned on a rear side 56 of guard 50. The upper panel assemblies 60 and lower panel assemblies 70 provide structural support for guard 50 such that guard 50 can stand upright. Upper panel assemblies 60 define a space 84 between each other. Top plate 82 is positioned on an upper portion of guard 50 such that top plate 82 extends across space 84. As shown, upper panel assemblies 60 and lower panel assemblies 70 shield object 58 in a vertical direction on a front side 54 and a rear side 56, and top plate 82 shields object 58 in a vertical direction between upper panel assemblies 60.

Upper panel assemblies 60 each generally include an upper panel 62 and two upper legs 66. Upper panel 62 extends between upper legs 66 and is generally rectangular in shape. In one embodiment, upper legs 66 are positioned along the longer sides of upper panel 62. In the shown embodiment, upper legs 66 are positioned on an interior-facing side of upper panel 62. Upper legs 66 may be distinct parts coupled to upper panel 62. For example, upper legs 66 can be coupled to upper panel 62 using one or more screws, bolts, rivets, nails, adhesives, welds, and/or other fasteners. In an alternative embodiment, upper panel assembly 60 can be unitarily constructed from a single piece of material.

Similarly, lower panel assemblies 70 each generally include a lower panel 72 and two lower legs 76. Lower panel 72 extends between lower legs 76 and is generally rectangular in shape. In one embodiment, lower legs 76 are positioned along the longer sides of lower panel 72. In the shown embodiment, lower legs 76 are positioned on an interior-facing side of lower panel 72. Lower legs 76 may be distinct parts coupled to lower panel 72. For example, lower legs 76 can be coupled to lower panel 72 using one or more screws, bolts, rivets, nails, adhesives, welds, and/or other fasteners. In an alternative embodiment, lower panel assembly 70 can be unitarily constructed from a single piece of material.

Lower panel assemblies 70 further include feet 80 that are positioned on lower portions of lower legs 76. Feet 80 provide stability for guard 50 when positioned on various ground surfaces. Feet 80 may be distinct parts coupled to lower legs 76. For example, feet 80 can couple to lower legs 76 using one or more screws, bolts, rivets, nails, adhesives, welds, and/or other fasteners. In one embodiment, feet 80 are made from rubber or another non-slip material. Feet 80 may be made from a material that is more flexible than the material of upper panel assemblies 60 and lower panel assemblies 70. In one embodiment, a lower surface of feet 80 is rounded such that the ground is tangent to the lower surface. In another embodiment, a lower surface of feet 80 has ridges which provide stability on loose ground, such as sand or dirt.

Upper panel assemblies 60 and lower panel assemblies 70 can be made from rigid materials that substantially resist deformation and withstand impacts. In one embodiment, upper panels 62 are made of the same material as upper legs 66, and lower panels 72 are made of the same material as lower legs 76. For example, all of one upper panel assembly 60 can be made of aluminum, and all of one lower panel assembly 70 can be made of aluminum. In an alternate embodiment, one or more parts of upper panel assemblies 60 and lower panel assemblies 70 can be made from a different metal, fiberglass, plastic, wood, and/or another rigid material. Additionally, the material composition of upper panel assemblies 60 and lower panel assemblies 70 in guard 50 may vary. For example, at least one of upper panel assemblies 60 and lower panel assemblies 70 is made of aluminum, and at least one of upper panel assemblies 60 and lower panel assemblies 70 is made of a different material. Alternatively, upper panel assemblies 60 and lower panel assemblies 70 can all be made of the same material.

Upper panel assemblies 60 are rotationally coupled to one another around an axis of rotation 86. Upper panel assemblies 60 define an angle of rotation 88 with respect to axis of rotation 86. Guard 50 can be placed in multiple configurations by varying angle of rotation 88. In one embodiment, guard 50 is in a closed configuration when angle of rotation 88 is below a threshold. The threshold is typically close to 0 degrees. In one example, guard 50 is in a closed configuration when angle of rotation 88 is below 5 degrees. In another example, guard 50 is in a closed configuration when angle of rotation 88 is 0 degrees. In an additional embodiment, guard 50 is in an open configuration when angle of rotation 88 is greater than the threshold of the closed configuration. Alternatively, the threshold may not determine whether guard 50 is in an open configuration. As examples, guard 50 is open when angle of rotation 88 is at a maximum value and/or when angle of rotation 88 is sufficient such that object 58 can be placed under guard 50.

Guard 50 is in a fully open configuration when angle of rotation 88 is at an upper limit. In one embodiment, upper panel assemblies 60 rotate relative to one another such that angle of rotation 88 does not exceed 45 degrees. In another embodiment, angle of rotation 88 does not exceed 180 degrees. In yet another embodiment, angle of rotation 88 does not exceed a value between 45 and 180 degrees. The maximum of angle of rotation 88 may be determined by the coupling between upper panel assemblies 60 and top plate 82. As examples, top plate 82 contacts upper panel assemblies 60, or upper panel assemblies 60 contact one another, at the maximum angle which prevents upper panel assemblies 60 from rotating further. Alternatively, guard 50 may include a stopping mechanism.

The rotational motion of upper panel assemblies 60 is selectable such that the positions of upper panel assemblies 60 may be fixed relative to one another at a desired angle of rotation 88. Guard 50 includes one or more latches, pins, buttons, locks, bolts, fasteners, clamps, frictional elements, and/or other mechanisms to selectively fix angle of rotation 88 between upper panel assemblies 60. For example, guard 50 includes a lock that can be pushed, pulled, or slid into and out of a position to fix angle of rotation 88. In one embodiment, angle of rotation 88 is selectively fixed in discrete increments. For example, angle of rotation 88 is selectable in increments of 5, 10, or 15 degrees. In an alternative embodiment, angle of rotation 88 is continuously selectable through the full range of rotation. In yet another embodiment, guard 50 is configured to fix angle of rotation 88 unless a user selectively rotates upper panel assemblies 60 that prevents upper panel assemblies 60 from rotating past a maximum angle.

Guard 50 further includes a mechanism for rotationally coupling upper panel assemblies 60 along axis of rotation 86. For example, upper panel assemblies 60 are rotationally coupled through one or more pins, hinges, axles, or other means of rotation. In the illustrated embodiment, upper panel assemblies 60 are rotationally coupled using hinge pins 90. One hinge pin 90 couples to the right side and one hinge pin 90 couples to the left side of upper panel assemblies 60. In an alternate embodiment, one hinge pin 90 couples to both the right and left sides of both upper panel assemblies 60.

Top plate 82 couples to an upper portion of guard 50 to cover space 84. In the illustrated embodiment, top plate 82 couples to guard 50 at axis of rotation 86. In another embodiment, top plate 82 couples to another portion of guard 50. Top plate 82 may rotate when there is a change in angle of rotation 88. Top plate 82 resists deformation and is made of a rigid material, for example rolled aluminum. In one embodiment, top plate 82 is made of the same material as upper panel assemblies 60 and/or lower panel assemblies 70.

Guard 50 defines a guard height 52. Each upper panel 62 defines an upper panel height 64, and upper legs 66 defines an upper leg height 68 on each upper panel assembly 60. Further, each lower panel 72 defines a lower panel height 74, and lower legs 76 defines a lower leg height 78 on each lower panel assembly 70. In the illustrated embodiment, each upper panel assembly 60 defines the same upper panel height 64 and upper leg height 68, and each lower panel assembly 70 defines the same lower panel height 74 and lower leg height 78. Upper leg height 68 may differ from upper panel height 64. Similarly, lower leg height 78 may differ from lower panel height 74. For example, upper leg height 68 may be greater than upper panel height 64 on upper panel assembly 60, and/or lower leg height 78 may be greater than lower panel height 74 on lower panel assembly 70. Upper legs 66 may extend below and/or above upper panel 62 in an upper panel assembly 60, and lower legs 76 may extend below and/or above lower panel 72 in a lower panel assembly 70. Further, upper panel height 64 may differ from lower panel height 74, and/or upper leg height 68 may differ from lower leg height 78.

At least one upper panel assembly 60 is positioned at least partially within a lower panel assembly 70, and/or at least one lower panel assembly 70 is positioned at least partially within an upper panel assembly 60. In the illustrated embodiment, both lower panel assemblies 70 are positioned within upper panel assemblies 60. Each upper panel assembly 60 is movably coupled to a lower panel assembly 70 such that upper panel assembly 60 slides relative to lower panel assembly 70 in a direction along upper panel height 64. Guard 50 is in an extended configuration when at least one upper panel assembly 60 has been slid along a coupled lower panel assembly 70 such that guard height 52 increases relative to a collapsed configuration. Guard 50 is fully extended when upper panel assemblies 60 have slid along coupled lower panel assemblies 70 to the fullest extent.

Guard 50 is in a collapsed configuration when at least one of front side 54 and rear side 56 are collapsed. In one embodiment, guard 50 is in a collapsed configuration when both front side 54 and rear side 56 are collapsed. One side of guard 50 is in a collapsed configuration when a lower panel assembly 70 is positioned within an upper panel assembly 60 to the fullest extent. In one embodiment, lower panel assembly 70 is fully nested within upper panel assembly 60 when one side of guard 50 is collapsed. In another embodiment, only some parts of lower panel assembly 70 are fully nested inside upper panel assembly 60. For example, lower legs 76 of a lower panel assembly 70 are fully nested within upper legs 66 of an upper panel assembly 60 and/or lower panel 72 of a lower panel assembly 70 is fully nested within an upper panel assembly 60 when guard 50 is in a collapsed configuration. In yet another embodiment, a portion of guard 50 contacts one of upper panel assembly 60 and lower panel assembly 70 and prevents lower panel assembly 70 from sliding further into upper panel assembly 60.

In the illustrated embodiment, lower legs 76 of a lower panel assembly 70 are positioned in interior portions of upper legs 66 of an upper panel assembly 60 that is movably coupled to lower panel assembly 70. Upper legs 66 are hollow such that an interior portion defines a channel to house lower legs 76. In an alternative embodiment, lower legs 76 are hollow and upper legs 66 are positioned within lower legs 76. Upper legs 66 are formed from sheets of rigid material, such that upper legs 66 maintain strength and stability while providing a hollow interior. For example, upper legs 66 can be formed from C-channel bars, U-channel bars, rectangular tube bars, or another type of hollow beam. In an alternate embodiment, upper legs 66 are formed by cutting or milling a channel into a solid piece of rigid material. Lower legs 76 may be formed similarly to the upper legs 66 or may be formed from a solid piece of rigid material.

The sliding movement of upper panel assemblies 60 and lower panel assemblies 70 is selectable such that upper panel assemblies 60 can be fixed in position relative to lower panel assemblies 70. Guard 50 may include one or more latches, pins, buttons, locks, bolts, fasteners, clamps, frictional elements, and/or other mechanisms to selectively fix the position of an upper panel assembly 60 relative to a lower panel assembly 70. In one embodiment, the movement of an upper panel assembly 60 relative to a lower panel assembly 70 is selectable in discrete increments along upper leg height 68. For example, the relative position of an upper panel assembly 60 can be selected from eight evenly spaced increments along upper leg height 68. In an alternative embodiment, the position of an upper panel assembly 60 relative to a lower panel assembly 70 is continuously selectable along upper leg height 68. In yet another embodiment, guard 50 is configured to fix the position of upper panel assemblies 60 relative to lower panel assemblies 70 unless a user attempts to slide an upper panel assembly 60 along a lower panel assembly 70.

In the shown embodiment, guard height 52 is selectable using one or more height setting pins 92 which are selectively coupled to one or more pin openings 94. Upper legs 66 and/or lower legs 76 define pin openings 94. In one embodiment, each upper leg 66 defines multiple pin openings 94 dispersed along upper leg height 68, and each lower leg 76 defines multiple pin openings 94 dispersed along lower leg height 78. Pin openings 94 may be dispersed in discrete intervals. For example, upper leg 66 defines eight evenly spaced openings along the leg height 68. In one embodiment, pin openings 94 extend through upper legs 66 and/or lower legs 76 from an exterior portion to an interior portion. In an alternate embodiment, pin openings 94 extend only partially through upper legs 66 and/or lower legs 76.

When one upper panel assembly 60 slides along one lower panel assembly 70, at least one height setting pin 92 is inserted into at least one pin opening 94 to fix upper panel assembly 60 in place relative to lower panel assembly 70. In one embodiment, one height setting pin 92 couples to a pin opening 94 on an upper leg 66 and a pin opening 94 on a lower leg 76. In another embodiment, one height setting pin 92 couples to only one pin opening 94 on one upper leg 66 or on one lower leg 76. For example, a height setting pin 92 can be movably coupled to a lower panel assembly 70 and can couple to a pin opening 94 on upper leg 66 of an upper panel assembly 60.

The position of upper panel assemblies 60 relative to lower panel assemblies 70 can be set independently on front side 54 and rear side 56 of guard 50. In one embodiment, upper panel assemblies 60 are positioned relative to lower panel assemblies 70 in the same way on front side 54 and rear side 56. In an alternate embodiment, upper panel assembly 60 is positioned at a different height along lower panel 70 on front side 54 than upper panel assembly 60 and lower panel assembly 70 on rear side 56. For example, guard 50 can be placed on a sloped surface and the position of upper panel assembly 60 can be raised or lowered along lower panel assembly 70 on one side to compensate for the slope.

Guard 50 optionally includes a pin receptacle 96 that couples to height setting pins 92. Pin receptacle 96 keeps height setting pins 92 attached to guard 50 when height setting pins 92 are removed from pin openings 94. Height setting pins 92 are U-shaped where one end couples to pin openings 94 and the other end couples to pin receptacle 96. Height setting pins 92 are free to rotate around the end of height setting pin 92 attached to pin receptacle 96. For example, a height setting pin 92 is removed from a pin receptacle 96 and is rotated away from pin opening 94. In one embodiment, pin receptacle 96 is biased to pull height setting pins 92 in an inward direction such that height setting pins 92 are held in a coupled position within pin openings 94.

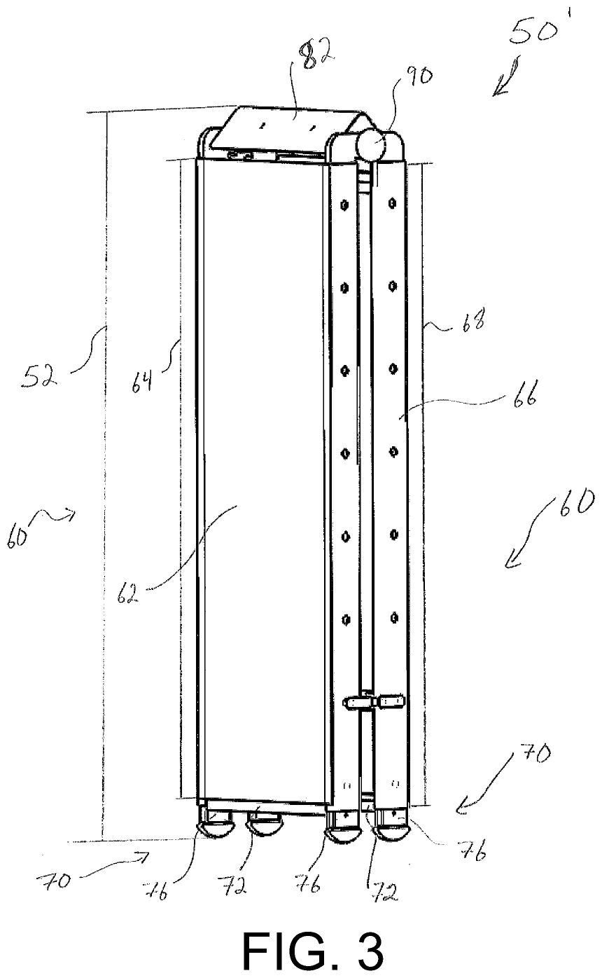

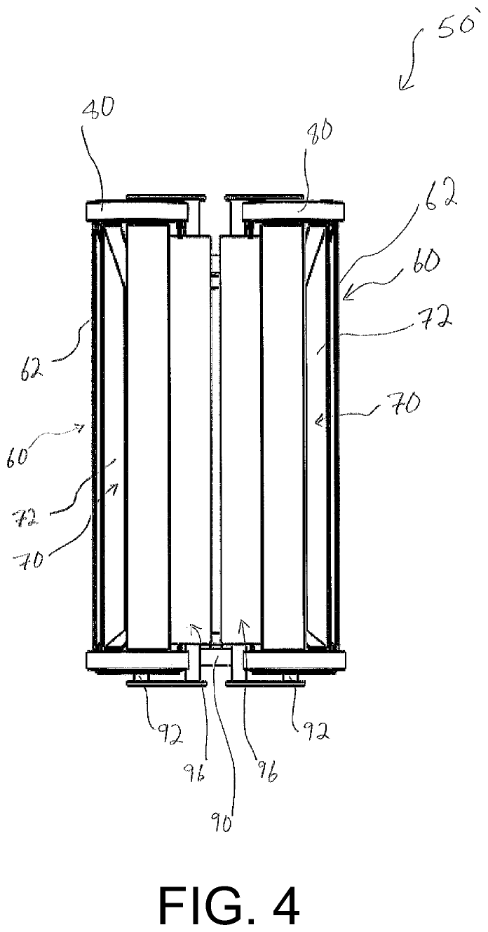

Referring to FIG. 3 and FIG. 4, guard 50′ can be placed in a closed and collapsed configuration. In the illustrated embodiment, angle of rotation 88 is zero (0) degrees. Additionally, lower panel assemblies 70 are fully nested within upper panels 60 in the illustrated embodiment of guard 50′. Guard 50′ may be arranged in a closed and collapsed configuration to be stored when not being used to protect object 58.

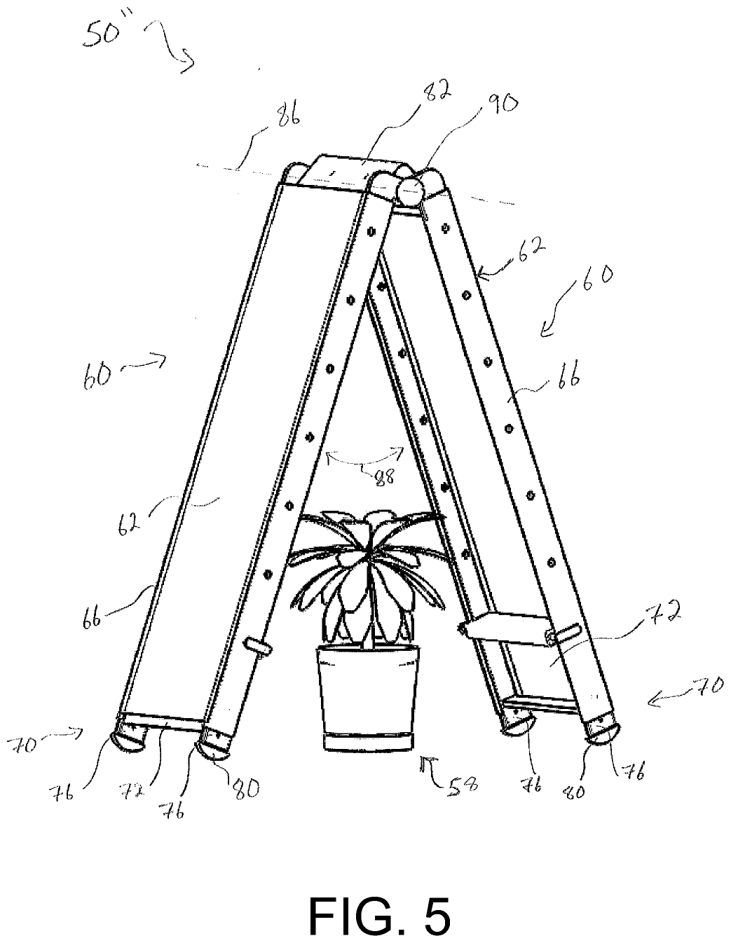

Referring to FIG. 5, guard 50″ can further be placed in a collapsed and open configuration to be positioned above object 58. As illustrated, lower panel assemblies 70 are fully nested within upper panel assemblies 60 in guard 50″. Further, guard 50″ may protect object 58 in a collapsed configuration if object 58 is small enough to fit underneath guard 50″ without extending guard height 52.

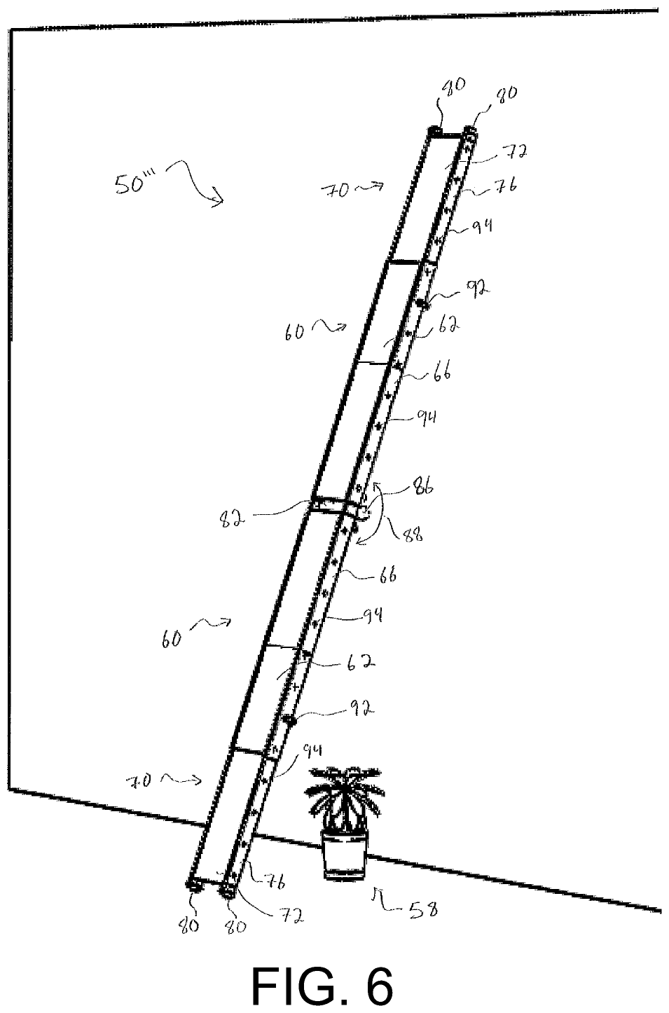

Referring to FIG. 6, guard 50″ can be placed in a fully extended and fully open configuration. As illustrated, upper panel assemblies 60 are rotated apart such that angle of rotation 88 is 180 degrees. When guard 50 is in a fully open configuration, one pair of feet 80 are positioned on the ground and the other pair of feet 80 are positioned against a wall or another structure. Alternatively, one pair of feet 80 may not be positioned against any structure.

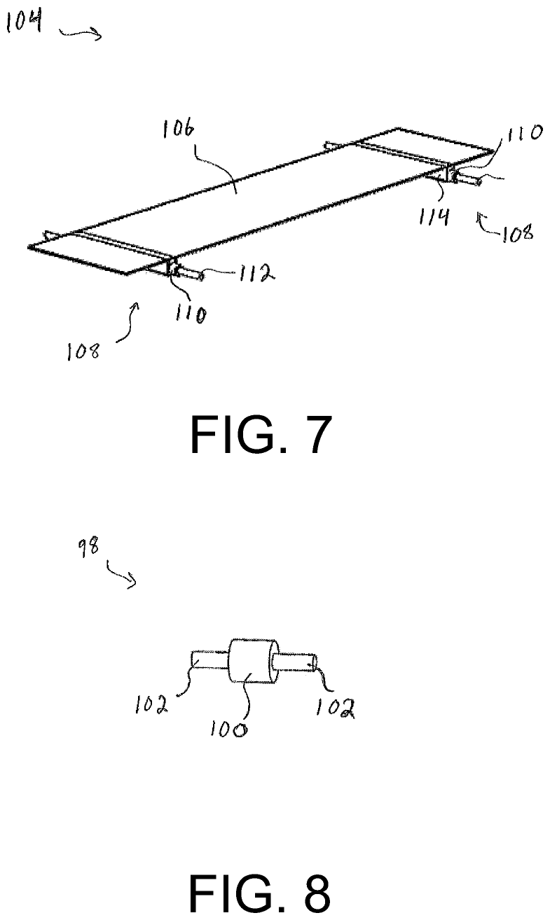

Referring to FIG. 7, an intermediate panel assembly 104 is configured to couple to a lateral side of guard 50. When intermediate panel assembly 104 is coupled to guard 50, a larger area is protected from falling objects. Intermediate panel assembly 104 may further couple to another guard 50 in order to protect the area between two guards 50.

Intermediate panel assembly 104 generally includes an intermediate panel 106 and two guard connecting bars 108. Intermediate panel 106 is generally rectangular in shape and is similar to upper panels 62 and lower panels 72 of guard 50. Intermediate panel 106 can be made of a rigid material that resists deformation and resists impacts, for example rolled aluminum. Guard connecting bars 108 are coupled to intermediate panel 106 on opposing ends. Intermediate panel 106 can be coupled to guard connecting bars 108 using one or more screws, bolts, rivets, nails, adhesives, welds, and/or other fasteners. In one embodiment, intermediate panel 106 couples to one or more fastener sheets 114 coupled to guard connecting bars 108.

Guard connecting bars 108 generally include a guard separator 110 and connector pins 112. Connector pins 112 are positioned on the right and left ends of intermediate panel assembly 104. Connector pins 112 couple to pin openings 94 on guard 50. In one embodiment, connector pins 112 are similar in size and shape to height setting pins 92, and pin openings 94 are configured to receive to both connector pins 112 and height setting pins 92. In an alternate embodiment, guard 50 defines separate openings configured to couple to connector pins 112. Guard separator 110 is positioned between connector pins 112 on guard connecting bar 108. When the connector pin 112 is positioned within pin opening 94, guard separator 110 contacts guard 50. When intermediate panel assembly 104 is coupled to a guard 50 on each side, guard separator 110 is positioned between guards 50 and prevents guards 50 from moving towards each other.

Referring to FIG. 8, an intermediate pin 98 is configured to couple two guards 50 together. Intermediate pin 98 generally includes connector pins 102 and a guard separator 100. Connector pins 102 couple to pin openings 94 on guard 50. In one embodiment, connector pins 102 are similar in size and shape to height setting pins 92, and pin openings 94 are configured to couple to both connector pins 102 and height setting pins 92. In an alternate embodiment, guard 50 defines separate openings configured to couple to connector pins 102. Guard separator 100 is positioned between connector pins 102 on guard connecting bar 108. When intermediate pin 98 is coupled to a guard 50 on each side, guard separator 100 is positioned between guards 50 and prevents guards 50 from moving towards each other.

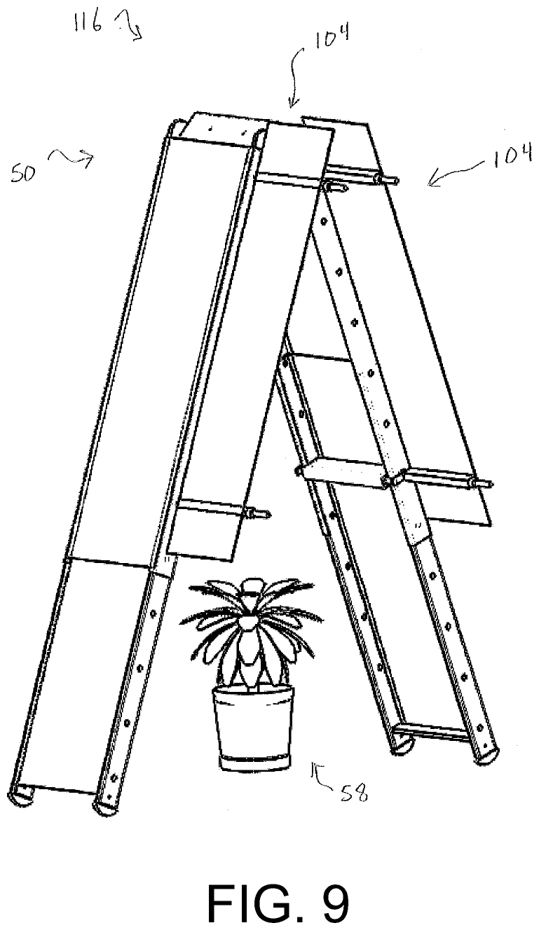

Referring to FIG. 9, a guard assembly 116 can be constructed from a guard 50 coupled to two intermediate panel assemblies 104. As illustrated, intermediate panel assemblies 104 are coupled to upper panel assemblies 60 and lower panel assemblies 70 of guard 50 on front side 54 and rear side 56. In the illustrated embodiment, the weight of guard 50 is substantial enough such that guard 50 maintains stability when intermediate panel assemblies 104 are coupled to guard 50 on one lateral side. In another embodiment, at least one intermediate panel assembly 104 is coupled to each lateral side of guard 50.

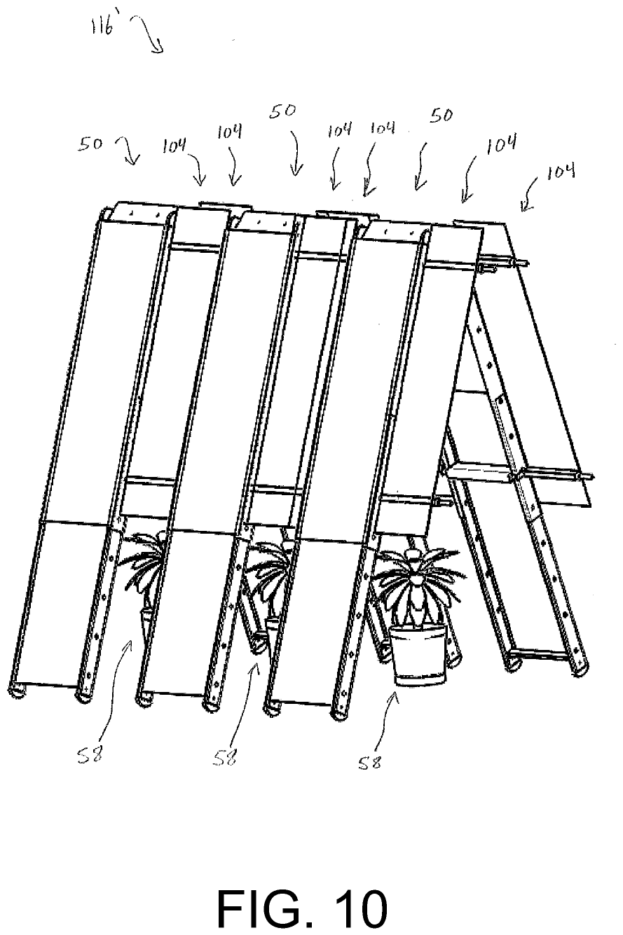

Referring to FIG. 10, another embodiment of a guard assembly 116′ can be constructed from multiple guards 50 coupled to multiple intermediate panel assemblies 104. As shown, each intermediate panel assembly 104 is coupled to two guards 50. Additionally, one guard 50 is coupled to two intermediate panel assemblies 104 on each lateral side. Guard assembly 116 can be expanded to include any number of guards 50 and intermediate panel assemblies 104. In one embodiment of guard assembly 116 at least one intermediate panel assembly 104 is coupled between every two guards 50.

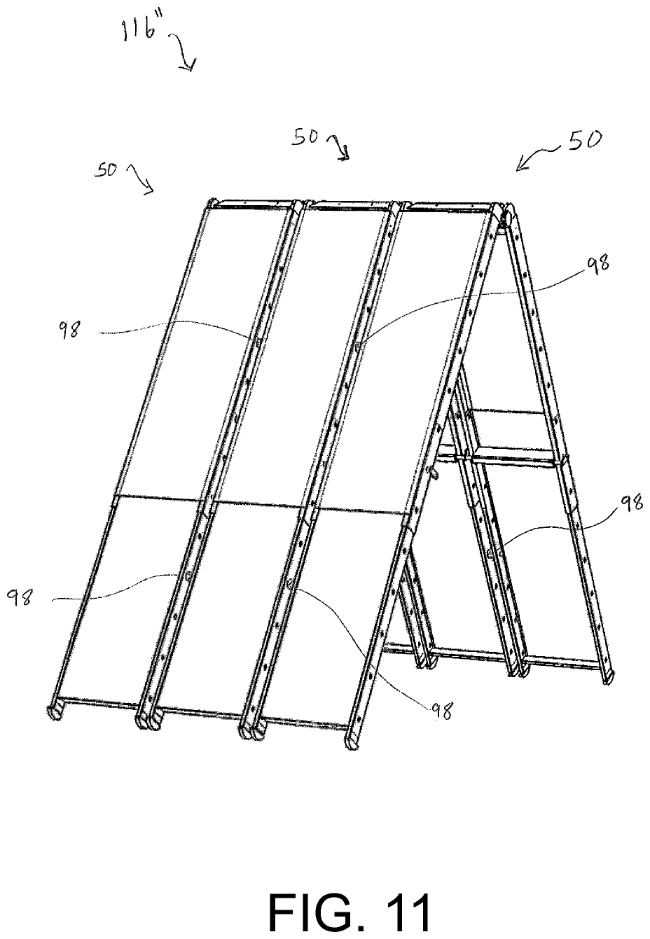

Referring to FIG. 11, yet another embodiment of a guard assembly 116″ includes multiple guards 50 coupled to multiple intermediate pins 98. In the shown embodiment, two intermediate pins 98 couple to each pair of guards 50 on each side. Guard assembly 116 can be expanded to include any number of guards 50. In one embodiment, at least one intermediate pin 98 is coupled between every two guards 50 in guard assembly 116″.

Further, guard assembly 116″ can include any number of guards 50 coupled using any combination of intermediate pins 98 and intermediate panel assemblies 104. For example, a guard 50 is coupled to one guard 50 using one or more intermediate panel assemblies 104 on one lateral side, and is coupled to another guard 50 using one or more intermediate pins 98 on the other lateral side.

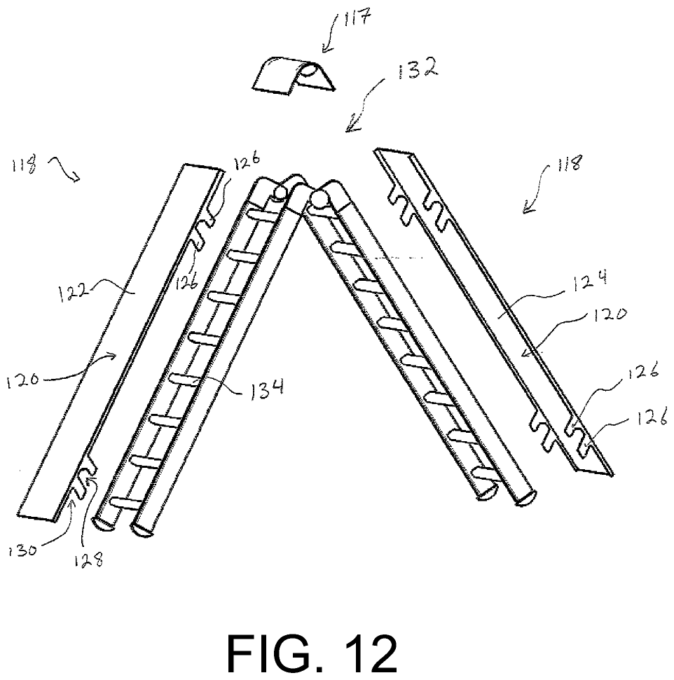

Referring to FIG. 12, a hood 117 and a barrier accessory 118 can be used to shield one or more objects 58 in a similar way as guard 50. Hood 117 and barrier accessory 118 are configured to couple to a ladder 132 on an exterior portion. In the illustrated example, ladder 132 is coupled to a barrier accessory 118 on each side and one hood 117 on an upper portion. Hood 117 and barrier accessory 118 may couple to a variety of ladder types. For example, hood 117 and barrier accessory 118 are designed to couple to step ladders, straight ladders, platform ladders, extension ladders, trestle ladders, and/or another type of ladder. The combined ladder 132, hood 117, and barrier accessory 118 are positioned above an object 58 to provide protection in a vertical direction. To withstand impacts and resist deformation, hood 117 and barrier accessory 118 are made of a rigid material. In one embodiment, hood 117 and barrier accessory 118 are made from the same material as guard 50.

Hood 117 is configured to couple to an upper portion of ladder 132, and/or an upper portion of one or more barrier accessories 118. Hood 117 covers a space between the sides of ladder 132 such that object 58 is protected from debris that may fall vertically between barrier accessories 118 on either side of ladder 132. The weight of hood 117 provides a downward force such that hood 117 is coupled against ladder 132 and/or barrier accessories 118.

Barrier accessory 118 generally includes an accessory panel 120 and one or more tabs 126. Accessory panel 120 is generally rectangular in shape and is similar to the front and rear panels of guard 50. The size and shape of accessory panel 120 may be determined based on a size and shape of a particular ladder 132. Accessory panel 120 includes a panel front side 122 and a panel rear side 124. Panel rear side 124 faces ladder 132 when barrier accessory 118 is attached. Panel front side 122 faces outwards to contact any falling objects.

Tabs 126 of barrier accessory 118 are positioned on panel rear side 124 and extend away from accessory panel 120. Tabs 126 contact one or more ladder rungs 124 when barrier accessory 118 is coupled to ladder 132. The weight of barrier accessory 118 provides a downward force through tabs 126 such that barrier accessory 118 is coupled against ladder 132. In one embodiment, tabs 126 are angled in a downward direction to conform to a portion of a surface of the ladder rungs 124.

In one embodiment, tabs 126 are positioned in pairs. When tabs 126 are arranged in pairs, one tab 126 is positioned above another tab 126. Two tabs 126 define an inter-tab space 128. The two tabs 126 are positioned such that a ladder rung 134 can be positioned in inter-tab space 128. Additionally, a tab 126 and panel rear side 124 define a sub-tab space 130. The ladder rungs 124 may be positioned in either of inter-tab spaces 128 or sub-tab spaces 130. In one embodiment, one or more ladder rungs 124 are positioned in inter-tab spaces 128 and one or more ladder rungs 124 are positioned in sub-tab spaces 130. Further, tabs 126 may be placed at various points along the width of accessory panel 120. In one embodiment, one tab 126 is positioned on the right end and one tab 126 is positioned on the left end of accessory panel 120. In an alternate embodiment, one or more tabs 126 extend between the right and left ends of accessory panel 120.

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

1. A guard for protecting an object, wherein at least a portion of said guard is configured to be positioned above at least a portion of the object, the guard comprising:
a front panel assembly comprising a front panel that extends between a right front leg and a left front leg, wherein said front panel is a continuous surface that extends down from a top terminal end of the right and left front legs, wherein said front panel defines a front panel height, wherein said right front leg and said left front leg define a front leg height, and wherein the front panel height is at least half the front leg height;
a rear panel assembly comprising a rear panel that extends between a right rear leg and a left rear leg, wherein said rear panel is a continuous surface that extends down from a top terminal end of the right and left front legs, wherein said rear panel defines a rear panel height, wherein said right rear leg and said left rear leg define a rear leg height, and wherein the rear panel height is at least half the rear leg height;
a gap between said front panel and said rear panel; and
a top panel coupled to an upper portion of said guard, wherein said top panel is larger than said gap and completely overlies said gap when viewed from above said top panel;
wherein said front panel assembly is selectively rotatable relative to said rear panel assembly about an axis of rotation, wherein said front panel assembly is selectively rotatable relative to said top panel, wherein said rear panel assembly is selectively rotatable relative to said top panel, wherein said front panel assembly and said rear panel assembly define an angle of rotation, and wherein said front panel assembly and said rear panel assembly are selectively rotatable such that said angle of rotation is selectable from between approximately 0 degrees to at least 45 degrees.

2. The guard of claim 1, further comprising:
a second front panel assembly comprising a second front panel that extends between a second right front leg and a second left front leg, wherein said second front panel defines a second front panel height, and wherein said second right front leg and said second left front leg define a second front leg height; and
a second rear panel assembly comprising a second rear panel that extends between a second right rear leg and a second left rear leg, wherein said second rear panel defines a second rear panel height, and wherein said second right rear leg and said second left rear leg define a second rear leg height;
wherein said second front panel assembly is selectively movable relative to said first front panel assembly in a direction along said front panel height, where moving said second front panel assembly relative to said first front panel assembly varies a height of the guard and wherein said first front panel overlaps said second front panel;
wherein said second rear panel assembly is selectively movable relative to said first rear panel assembly in a direction along said rear panel height, where moving said second rear panel assembly relative to said first rear panel assembly varies a height of the guard and wherein said first rear panel overlaps said second rear panel; and
wherein a guard height is defined between an upper portion and a lower portion of said guard, and wherein said guard height is altered when one or both of said first front panel assembly and said first rear panel assembly are moved relative to said second front panel assembly or said second rear panel assembly, respectively.

3. The guard of claim 2, wherein said front and rear legs define multiple first openings dispersed along said front and rear leg heights, and wherein said second front and rear legs defines multiple second openings dispersed along said second front and rear legs and further comprising:
a height setting pin adapted to extend into a first opening and a second opening, wherein the position of one of said first panel assemblies relative to one of said second panel assemblies is selectively fixed when said height setting pin is positioned within a first and second opening.

4. The guard of claim 3, further comprising:
a pin receptacle that is coupled to one of said front and rear panel assemblies, wherein said height setting pin is movably coupled to said pin receptacle;
wherein said height setting pin is movable between a first pin position and a second pin position, wherein said height setting pin is positioned within said openings in said first pin position, and wherein said height setting pin is positioned outside said openings in said second pin position.

5. The guard of claim 2, wherein said second right front leg is nested within said first right front leg, wherein said second left front leg is nested within said first left front leg, and wherein said first front panel assembly is movably coupled to said second front panel assembly through said front legs; and
wherein said second right rear leg is nested within said first right rear leg, and wherein said second left rear leg is nested within said first left rear leg, and wherein said first rear panel assembly is movably coupled to said second rear panel assembly through said rear legs.

6. The guard of claim 1, further comprising:
a hinge pin that rotatably couples said front panel assembly, said rear panel assembly and said top panel, wherein said hinge pin is aligned along said axis of rotation.

7. The guard of claim 1, wherein said angle of rotation is selectable up to 180 degrees.

8. The guard of claim 1, wherein at least one of said front and rear legs further comprises a foot on a lower portion.

9. The guard of claim 8, wherein a lower surface of said foot is rounded.

10. The guard of claim 1, wherein at least one of said front and rear panels is made of rolled aluminum.

11. (canceled)

12. The guard of claim 1, wherein at least one of said front and rear panel assemblies is monolithic in construction.

13. The guard of claim 2, wherein at least one of said second front panel and said second rear panel is nested respectively within said first front panel assembly or said first rear panel assembly.

14. The guard of claim 1, wherein said guard is configured to withstand the impact of an object that is at least 240 lbs. and that is falling from at least 20 feet above the ground.

15. A guard assembly, comprising:
a first guard, wherein said first guard is a guard according to claim 1, and wherein at least one of said right legs of said first guard defines at least two openings;
a second guard, wherein said second guard is a guard according to claim 1, and wherein at least one of said left legs of said second guard defines at least two openings; and
an intermediate panel assembly comprising an intermediate panel that extends between an upper connector bar and a lower connector bar;
wherein said intermediate panel assembly is positioned between said first guard and said second guard when said first guard is spaced apart from said second guard such that said intermediate panel extends across the space between said first guard and said second guard; and
wherein each of said upper connector bar and said lower connector bar couple to an opening on said right front leg of said first guard and to an opening on said left front leg of said second guard.

16. The guard assembly of claim 15, further comprising:
a second intermediate panel assembly comprising a second intermediate panel that extends between a second upper connector bar and a second lower connector bar;
wherein said second intermediate panel assembly is positioned between said first guard and said second guard when said first guard is spaced apart from said second guard such that said second intermediate panel extends across the space between said first guard and said second guard; and
wherein each of said second upper connector bar and said second lower connector bar couple to an opening on said right rear leg of said first guard and to an opening on said left rear leg of said second guard.

17. The guard assembly of claim 16, wherein said guard assembly comprises more than two guards and more than one intermediate panel assembly, wherein at least one intermediate panel assembly is positioned between and coupled to every two consecutive guards.

18. A guard assembly, comprising:
a first guard, wherein said first guard is a guard according to claim 1, and wherein at least one of said right legs of said first guard defines at least one opening;
a second guard, wherein said second guard is a guard according to claim 1, and wherein at least one of said left legs of said second guard defines at least one opening; and
an intermediate pin, wherein said intermediate pin is positioned between said first guard and said second guard;
wherein said intermediate pin couples to an opening on said right front leg of said first guard and to an opening on said left front leg of said second guard.

19-23. (canceled)

24. The guard assembly of claim 1, further comprising a right hinge that rotatably couples said right front leg to said right rear leg and a left hinge that rotatably couples said left front leg to said left rear leg.

25. (canceled)

26. The guard assembly of claim 24, wherein said top panel is a unitary structure that extends between the right hinge and the left hinge.

27. The guard assembly of claim 1, wherein the front panel extends down from the top terminal end of the right and left front legs a majority of the front leg height and wherein the rear panel extends down from the top terminal end of the right and left front legs a majority of the rear leg height.
